(19) United States
(12) Patent Application Publication
(10) Pub. No.: US 2016/0204442 A1
(43) Pub. Date: Jul. 14, 2016

(54) MIXED-METAL OXIDE CATALYST LAYER WITH SACRIFICIAL MATERIAL

(71) Applicant: Nissan North America, Inc., Franklin, TN (US)

(72) Inventors: Nilesh Dale, Novi, MI (US); Kan Huang, Farmington Hills, MI (US); Ellazar Niangar, Redford, MI (US); Dianne Atienza, Farmington Hills, MI (US)

(21) Appl. No.: 14/592,166

(22) Filed: Jan. 8, 2015

(51) Int. Cl. H01M 4/86; H01M 4/90; H01M 4/92

(52) U.S. Cl. CPC H01M 4/8652; H01M 4/925; H01M 4/9075; H01M 4/9091; H01M 4/8673

(57) ABSTRACT

A composite electrocatalyst layer comprises catalyst particles having non-carbon metal oxide support particles and precious metal particles deposited on the non-carbon metal oxide support particles. Carbon particles are mixed with, but discreet from, the catalyst particles. The catalyst particles can be titanium dioxide and ruthenium dioxide support with platinum deposited on the support. Electrodes are produced using the composite electrocatalyst.

### TECHNICAL FIELD

This disclosure relates to a mixed metal oxide catalyst layer with sacrificial material, and in particular, to a titanium-ruthenium oxide catalyst layer with sacrificial carbon.

### BACKGROUND

Carbon has traditionally been the most common material of choice for polymer electrolyte fuel cell (PEFC) electrocatalyst supports due to its low cost, high abundance, high electronic conductivity, and high Brunauer, Emmett, and Teller (BET) surface area, which permits good dispersion of platinum (Pt) active catalyst particles. However, the instability of the carbon-supported platinum electrocatalyst due at least in part to carbon corrosion is a key issue that currently precludes widespread commercialization of PEFCs for automotive applications.

The adverse consequences of carbon corrosion include (i) platinum nanoparticle agglomeration/detachment; (ii) macroscopic electrode thinning/loss of porosity in the electrode; and (iii) enhanced hydrophilicity of the remaining support surface. The first results in loss of catalyst active surface area and lower mass activity resulting from reduced platinum utilization, whereas the second and third result in a lower capacity to hold water and enhanced flooding, leading to severe condensed-phase mass transport limitations. Clearly, both consequences directly impact PEFC cost and performance, especially in the context of automotive stacks.

To address the issues with carbon-based catalyst, non-carbon alternatives are being investigated. However, non-carbon alternatives are typically cost-prohibitive, and corrosion of the non-carbon alternatives can still occur.

### SUMMARY

A composite electrocatalyst layer is disclosed comprising catalyst particles comprising non-carbon metal oxide support particles with precious metal particles deposited on the non-carbon metal oxide support particles. Carbon particles are mixed with, but discreet from, the catalyst particles.

Another embodiment of the composite electrocatalyst disclosed herein comprises catalyst particles comprising non-carbon metal oxide support particles of titanium dioxide and ruthenium dioxide, and precious metal particles deposited on the non-carbon metal oxide support particles. Sacrificial particles of a material selected to provide conductivity while corroding sacrificially, are mixed with, but discreet from, the catalyst particles.

Also disclosed are electrodes for fuel cells using the composite electrocatalysts disclosed herein.

These and other aspects of the present disclosure are disclosed in the following detailed description of the embodiments, the appended claims and the accompanying figures.

### BRIEF DESCRIPTION OF THE DRAWINGS

The various features, advantages and other uses of the present apparatus will become more apparent by referring to the following detailed description and drawing in which:

FIG. 1 is a schematic illustrating an embodiment of the composite electrocatalyst as disclosed herein;

FIG. 2 is a schematic illustrating another embodiment of the composite electrocatalyst as disclosed herein;

FIG. 3 is a flow diagram of an example method of preparing a composite electrocatalyst as disclosed herein; and

FIG. 4 is a schematic of a fuel cell using the composite electrocatalyst as disclosed herein.

### DETAILED DESCRIPTION

A viable alternative non-carbon support should possess high surface area and electron conductivity, in addition to being highly corrosion resistant across the anticipated potential/pH window. Certain non-carbon metal oxide catalyst supports meet these criteria.

One example of a non-carbon metal oxide catalyst support consists essentially of a non-conductive metal oxide such as titanium dioxide. Titanium dioxide (TiO₂) has very good chemical stability in acidic and oxidative environments. However, titanium dioxide is a semiconductor and its electron conductivity is very low. Substoichiometric titanium oxides (Ti₂O₃, Ti₄O₇, Magnéli phases) obtained by heat treatment of TiO₂ in a reducing environment (i.e., hydrogen, carbon) have electron conductivity similar to graphite as a consequence of the presence of oxygen vacancies in the crystalline lattice. However, the heat treatment process reduces the surface area of these materials, precluding the preparation of supported electrocatalysts with good Pt dispersion.

To overcome the deficiencies of the non-conductive metal oxide alone, a non-carbon metal oxide support having both a non-conductive oxide and a conductive oxide have been developed. For example, a non-carbon mixed-metal oxide support of TiO₂ and conductive metal oxides such as oxides of ruthenium have been developed. Oxides of ruthenium include varying ruthenium/oxygen ratios, such as ruthenium dioxide (RuO₂) and ruthenium tetroxide (RuO₄). The non-carbon metal oxide support particle consists essentially of titanium dioxide and oxides of ruthenium. The titanium and ruthenium can have a mole ratio ranging between 1:1 and 9:1 in the non-carbon metal oxide support particle, and the particle sizes of the titanium dioxide and the oxides of ruthenium can be substantially equal. Alternatively, the ruthenium based particles can be smaller than the titanium dioxide particles, with the oxides of ruthenium deposited on the titanium dioxide. A precious metal active catalyst particle such as platinum is deposited on the TiO₂—RuO₂ support.

TiO₂—RuO₂based catalyst provides excellent activity while being stable. However, due to the increased activity of the TiO₂—RuO₂based catalyst, less catalyst is required. A required electrode thickness requires a certain amount of the catalyst. Ruthenium is expensive, and using an amount of the TiO₂—RuO₂ based catalyst required to achieve the requisite activity can result in an electrode catalyst layer that is thinner than desired. Using an amount of the TiO₂—RuO₂ based catalyst to achieve the desired thickness can result in using more catalyst than necessary to achieve the desired activity, potentially rendering the catalyst uneconomical.

Disclosed herein are embodiments of composite electrocatalysts that optimize the catalyst layer of the electrode with regard to thickness, activity and economics. One embodiment of a composite electrocatalyst layer is schematically illustrated in FIG. 1. The composite electrocatalyst layer 10 comprises catalyst particles 12 consisting essentially of non-carbon metal oxide support particles 14 with precious metal particles 16 deposited on the non-carbon metal oxide support particles 14, and carbon particles 18 mixed with, but discreet from, the catalyst particles 12.

The carbon particles 18 contribute to the conductivity of the catalyst layer and act as a sacrificial particle for corrosion. The carbon particles 18 also can be used to optimize the thickness of the catalyst layer in the electrode without any significant increase in cost. Because the precious metal particles 16 are deposited on the non-carbon metal oxide support particles 14 rather than the carbon particles 18, a high surface area carbon typically used as a carbon catalyst support is not necessary. The carbon used in the composite electrocatalyst layer 10 can be a low surface area carbon such as graphitized carbon. Because the precious metal particles 16 are not supported on the carbon particles 18, precious metal detachment and agglomeration of the precious metal particles 16 can be prevented. As the fuel cell is used, the carbon particles 18 in the catalyst layer 10 will sacrificially corrode, prolonging the life of the metal oxides used in the non-carbon metal oxide support particles 14. Carbon particles 18 can be used to bulk up the thickness of the catalyst layer 10 as required by the electrode, without having to increase the amount of an expensive catalyst component such as a metal oxide or the precious metal.

The carbon particles 18 can simply be mixed with the prepared catalyst 12. There is no need to couple or deposit the carbon particles 18 onto the catalyst particles 12. As noted, the carbon particles 18 can be graphite, graphene, and any other carbon that material that will provide sufficient conductivity without needing to provide surface area for precious metal particles. Of course, if desired, carbon blacks, such as Vulcan®, Ketjenblack®, Black Pearl™ and acetylene black, can also be used. Other examples include raw carbon with no structured porosity or carbon precursors, carbon nanotubes, micro-pore controlled structured carbon types.

The precious metal particles 16 can include one or a combination of precious metals such as platinum, gold, rhodium, ruthenium, palladium and iridium, and/or transition metals such as cobalt and nickel. The precious metal can be in various forms, such as alloys, nanowires, nanoparticles and coreshells, which are bimetallic catalysts that possess a base metal core surrounded by a precious metal shell.

The non-carbon metal oxide support particles 14 can be one or more metal oxides prepared with varying ratios of metal oxides and various particle sized depending on the metal oxides used. The non-carbon metal oxide support particles 14 can be nanotubes or core shells. In one embodiment, the non-carbon metal oxide support particles are a non-conductive metal oxide, such as titanium dioxide. The carbon particles 18 provide the electroconductivity that the non-conductive metal oxide lacks.

Alternatively, a modified non-conductive metal oxide can be used. The modified non-conductive metal oxide is obtained by doping the non-conductive oxide with a dopant such as niobium and tantalum. One or more dopants can be used. The modified non-conductive metal oxide is more conductive than the unmodified non-conductive metal oxide, and contributes conductivity to the catalyst layer.

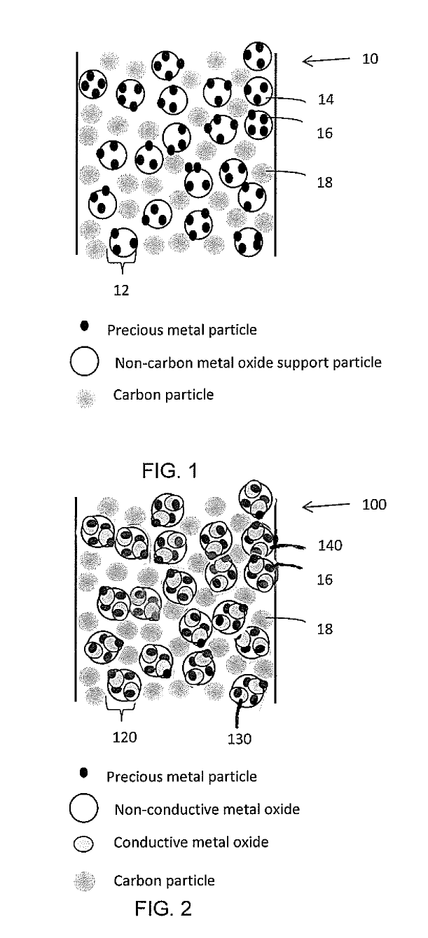

In a catalyst layer 100 using another embodiment of a composite electrocatalyst 120 shown in FIG. 2, the non-carbon metal oxide support particles comprise a non-conductive metal oxide 140 and a conductive metal oxide 130. The non-conductive metal oxide 140 can be, for example, titanium dioxide and the conductive metal oxide 130 can be, for example, oxides of ruthenium. The oxides of ruthenium can be one or both of ruthenium dioxide and ruthenium tetroxide. Other oxides of ruthenium can be used as known to those skilled in the art. The non-carbon metal oxide support particles can also consist essentially of only titanium dioxide and an oxide of ruthenium. The oxide of ruthenium can be deposited onto the titanium dioxide to form the non-carbon metal oxide support particles. The particle diameter of the oxide of ruthenium can be smaller than the particle diameter of the titanium dioxide. Alternatively, the particle diameters of the titanium dioxide and the oxide of ruthenium can be essentially equal. The titanium dioxide can be a modified titanium dioxide doped with a dopant, such as one or both of niobium and tantalum.

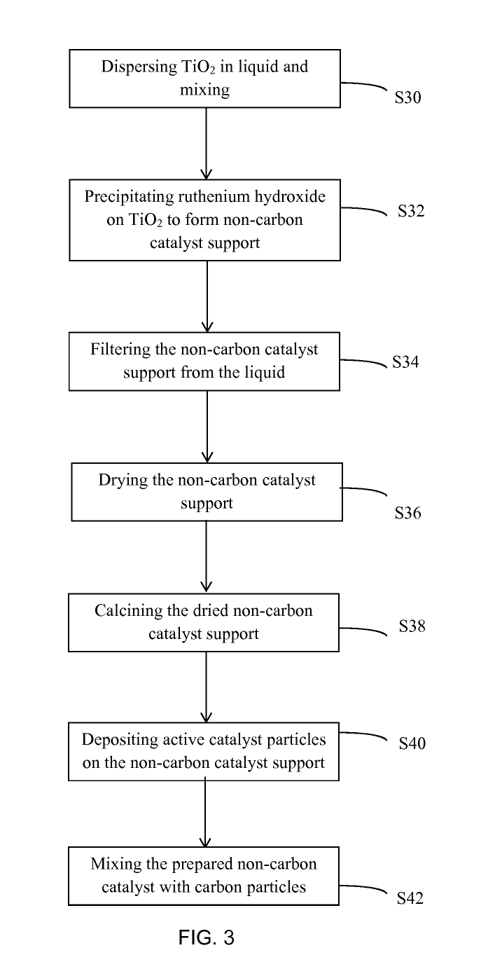

As shown in FIG. 3, an illustrative example of a method of preparing an embodiment of the electrocatalyst 12 disclosed herein comprises dispersing titanium dioxide nanopowder in liquid and mixing for a first period of time in step S30. In step S32, ruthenium hydroxide is precipitated on the titanium dioxide nanopowder to form non-carbon metal oxide support particles consisting essentially of titanium dioxide and ruthenium dioxide. The non-carbon metal oxide support particles are filtered from the liquid in step S34 and dried in step S36. The dried non-carbon metal oxide support particles can be calcined in step S38, at 450° C., for example. Precious metal active particles 16 are deposited on the non-carbon metal oxide support particles in step S40 by reducing an active catalyst precursor with acid. The precious metal active particles can be platinum particles, as a non-limiting example. In step S42, the prepared non-carbon catalyst particles 12 are mixed with the carbon particles 18 to form the composite electrocatalyst 10 for use in electrodes in fuel cells.

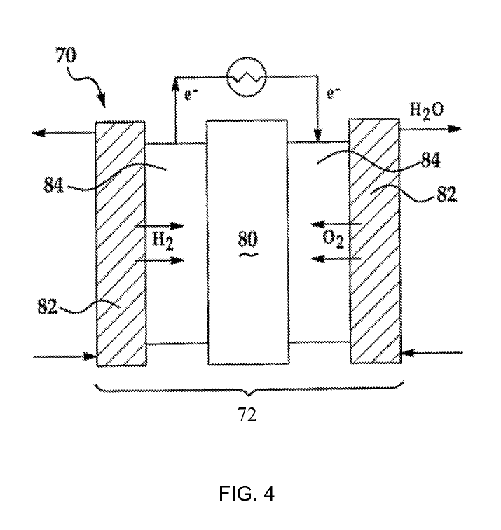

FIG. 4 illustrates the use of the composite electrocatalyst disclosed herein in a fuel cell electrode. FIG. 4 is a schematic of a fuel cell 70, a plurality of which makes a fuel cell stack. The fuel cell 70 is comprised of a single membrane electrode assembly 72. The membrane electrode assembly 72 has a membrane 80 coated with the composite electrocatalyst 84 with a gas diffusion layer 82 on opposing sides of the membrane 80. The membrane 80 has a layer of the composite electrocatalyst 84 formed on opposing surfaces of the membrane 80, such that when assembled, the layers of the composite electrocatalyst are each between the membrane 80 and a gas diffusion layer 82. Alternatively, a gas diffusion electrode is made by forming one layer of the composite electrocatalyst 84 on a surface of two gas diffusion layers 82 and sandwiching the membrane 80 between the gas diffusion layers 82 such that the layers of composite electrocatalyst 84 contact the membrane 80. When fuel, such as hydrogen gas (shown as H₂), is introduced into the fuel cell 70, the layer of composite electrocatalyst 84 splits hydrogen gas molecules into protons and electrons. The protons pass through the membrane 80 to react with the oxidant (shown as O₂), such as oxygen or air, forming water (H₂O). The electrons (e⁻), which cannot pass through the membrane 80, must travel around it, thus creating the source of electrical energy.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A composite electrocatalyst layer comprising:
catalyst particles consisting essentially of non-carbon metal oxide support particles with precious metal particles deposited on the non-carbon metal oxide support particles; and
carbon particles mixed with, but discreet from, the catalyst particles.

2. The composite electrocatalyst layer of claim 1, wherein the carbon particles are graphitized carbon.

3. The composite electrocatalyst layer of claim 1, wherein the carbon particles are of a carbon having a surface area too low to perform as a catalyst support.

4. The composite electrocatalyst layer of claim 1, wherein the precious metal particles are platinum.

5. The composite electrocatalyst layer of claim 1, wherein the non-carbon metal oxide support particles comprise a non-conductive metal oxide.

6. The composite electrocatalyst layer of claim 1, wherein the non-conductive metal oxide is titanium dioxide.

7. The composite electrocatalyst layer of claim 5, wherein the non-conductive metal oxide is a modified non-conductive metal oxide doped with a dopant.

8. The composite electrocatalyst layer of claim 1, wherein the non-carbon metal oxide support particles comprise a non-conductive metal oxide and a conductive metal oxide.

9. The composite electrocatalyst layer of claim 8, wherein the non-conductive metal oxide is titanium dioxide and the conductive metal oxide is an oxide of ruthenium.

10. The composite electrocatalyst layer of claim 9, wherein oxide of ruthenium is one or both of ruthenium dioxide and ruthenium tetroxide.

11. The composite electrocatalyst layer of claim 9, wherein the oxide of ruthenium is deposited onto the titanium dioxide to form the non-carbon metal oxide support particles.

12. The composite electrocatalyst layer of claim 9, wherein the titanium dioxide is a modified titanium dioxide doped with a dopant.

13. An electrode for a fuel cell, comprising the composite electrocatalyst layer of claim 1.

14. A composite electrocatalyst layer comprising:
catalyst particles comprising non-carbon metal oxide support particles of titanium dioxide and ruthenium dioxide, and precious metal particles deposited on the non-carbon metal oxide support particles; and
sacrificial particles of a material selected to provide conductivity while corroding sacrificially, wherein the sacrificial particles are mixed with, but discreet from, the catalyst particles.

15. The composite electrocatalyst layer of claim 14, wherein the material is a carbon.

16. The composite electrocatalyst layer of claim 14, wherein the material is graphitized carbon.

17. The composite electrocatalyst layer of claim 14, wherein the material is a carbon having a surface area too low to perform as a catalyst support.

18. The composite electrocatalyst layer of claim 14, wherein the precious metal particles are platinum.

19. The composite electrocatalyst layer of claim 14, wherein the titanium dioxide is a modified titanium dioxide doped with a dopant.

20. An electrode for a fuel cell, comprising the composite electrocatalyst layer of claim 14.
